(19) United States
(12) Patent Application Publication
(10) Pub. No.: US 2010/0317792 A1
(43) Pub. Date: Dec. 16, 2010

(54) PRESSURE-SENSITIVE ADHESIVE TAPE FOR OPTICAL MEMBER

(75) Inventors: Shou Takarada, Osaka (JP); Takahiro Nonaka, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Osaka (JP)

(21) Appl. No.: 12/813,057

(22) Filed: Jun. 10, 2010

(30) Foreign Application Priority Data
Jun. 11, 2009 (JP) 2009-140500

(51) Int. Cl. C08L 33/10

(52) U.S. Cl. 524/556

(57) ABSTRACT

The present invention provides a pressure-sensitive adhesive tape for optical member, which has a toluene emission amount of at most 10 μg/g and a formaldehyde emission amount of at most 3 μg/g. The pressure-sensitive adhesive tape may include an acrylic pressure-sensitive adhesive layer. The pressure-sensitive adhesive tape of the invention is favorable for use for in-vehicle installation, and for use for members near to users such as lenses, panels, etc.

### FIELD OF THE INVENTION

The present invention relates to a pressure-sensitive adhesive tape for optical member, which is used for purposes of bonding optical members, etc.

### BACKGROUND OF THE INVENTION

Heretofore, display devices such as liquid-crystal displays (LCD) and input devices to be combined with the display devices such as touch panels have become widely used in various fields. In producing such display devices and input devices, transparent pressure-sensitive adhesive tapes are used for purposes of bonding optical members, etc. For example, transparent double-sided pressure-sensitive adhesive tapes are used for bonding various display devices such as touch panels, and optical members such as protective plates (for example, see Patent References 1 to 3).

Recently, the above-mentioned display devices and the like have become broadly used for in-vehicle installation, and pressure-sensitive adhesive tapes have become much used for members near to users such as lenses, panels, etc. To that effect, with the increase in the frequency of use thereof in a relatively narrow closed space and use thereof near to humans, pressure-sensitive adhesive tapes for optical members, from which the release of volatile organic compounds (VOC) and odor is reduced, are strongly desired.

Patent Reference 1: JP-A 2003-238915

Patent Reference 2: JP-A 2003-342542

Patent Reference 3: JP-A 2004-231723

### SUMMARY OF THE INVENTION

Accordingly, an object of the invention is to provide a pressure-sensitive adhesive tape for optical member, from which the release of odor and VOC is extremely small.

The present inventors have assiduously studied for the purpose of attaining the above-mentioned object and, as a result, have found that when the toluene emission amount and the formaldehyde emission amount from a pressure-sensitive adhesive tape for optical member are reduced to a predetermined level or less, then a pressure-sensitive adhesive tape for optical member that releases few odor and VOC can be obtained. On the basis of this finding, the inventors have completed the present invention.

Namely, the present invention provides the following items 1 to 7.

1. A pressure-sensitive adhesive tape for optical member, which has a toluene emission amount of at most 10 μg/g and a formaldehyde emission amount of at most 3 μg/g.

2. The pressure-sensitive adhesive tape for optical member according to item 1, which comprises an acrylic pressure-sensitive adhesive layer.

3. The pressure-sensitive adhesive tape for optical member according to item 1 or 2, which has a whole light transmittance of at least 90%.

4. The pressure-sensitive adhesive tape for optical member according to any one of items 1 to 3, which has a peel adhesion force (with respect to acrylic plate, 180° peeling) of at least 10 N/25 mm.

5. The pressure-sensitive adhesive tape for optical member according to any one of items 1 to 4, which is a substrate less pressure-sensitive adhesive tape having no substrate.

6. The pressure-sensitive adhesive tape for optical member according to item 2, wherein the acrylic pressure-sensitive adhesive layer contains an acrylic polymer formed of, as an indispensable monomer ingredient, an alkyl (meth)acrylate having a linear or branched alkyl group having from 1 to 14 carbon atoms, and/or an alkoxyalkyl (meth)acrylate.

7. The pressure-sensitive adhesive tape for optical member according to item 2, wherein the acrylic pressure-sensitive adhesive layer is formed of a pressure-sensitive adhesive composition prepared in accordance with a UV polymerization method through irradiation with UV rays.

According to the pressure-sensitive adhesive tape for optical member of the invention, the toluene emission amount and the formaldehyde emission amount therefrom is defined to be not higher than a predetermined level, so that the release of odor and VOC from the tape is reduced. Accordingly, the pressure-sensitive adhesive tape for optical member of the invention is favorable for use for in-vehicle installation, and for use for members near to users such as lenses, panels, etc.

### DETAILED DESCRIPTION OF THE INVENTION

Embodiments of the invention are described in detail hereinunder.

The pressure-sensitive adhesive tape for optical member of the invention (hereinafter this may be simply referred to as “pressure-sensitive adhesive tape of the invention”) is a pressure-sensitive adhesive tape for use for bonding optical members, etc, from which the emission amount of toluene (toluene emission amount) is at most 10 μg/g and the emission amount of formaldehyde (formaldehyde emission amount) is at most 3 μg/g.

The pressure-sensitive adhesive tape of the invention may be a double-sided pressure-sensitive adhesive tape of which the both faces are pressure-sensitive adhesive faces (pressure-sensitive adhesive layer surfaces), or a single-sided pressure-sensitive adhesive tape of which one face alone is a pressure-sensitive adhesive face. Above all, preferred is a double-sided pressure-sensitive adhesive tape from the viewpoint of bonding two members to each other with it. In the invention, “pressure-sensitive adhesive tape” includes a sheet-like one, or that is, “pressure-sensitive adhesive sheet”.

The toluene emission amount from the pressure-sensitive adhesive tape of the invention is at most 10 μg/g, preferably at most 5 μg/g, more preferably at most 3 μg/g, most preferably at most 1 μg/g. When the toluene emission amount is more than 10 μg/g, then it is unfavorable since the odor and VOC to be released from the pressure-sensitive adhesive tape may increase. The toluene emission amount can be measured, for example, according to “Method for Measuring Toluene Emission Amount” described below.

### Method for Measuring Toluene Emission Amount

In case where the pressure-sensitive adhesive tape for optical member is a double-sided pressure-sensitive adhesive tape, the pressure-sensitive adhesive tape is cut into a piece having a predetermined size (5 cm length×1 cm width, test area 5 cm²); and when it has a separator, the separator is removed. One side (pressure-sensitive adhesive face) is stuck to an aluminium foil, and the other side is left open; and in this manner, a test sample is prepared. On the other hand, in case where the pressure-sensitive adhesive tape for optical member is a single-sided pressure-sensitive adhesive tape, this is not stuck to an aluminium foil. The tape is cut into a piece having a predetermined size (5 cm length×1 cm width, test area 5 cm²); and when it has a separator, the separator is removed, and a test sample is thus prepared. The sample is weighed, then put into a 20-mL, vial bottle and sealed up. Subsequently, the vial bottle with the sample therein is heated at 150° C. for 30 minutes, using a headspace autosampler (HSS); and 1.0 mL of the gas being heated is introduced into a gas chromatographic device (GC) to analyze it therein. The analytical instrumentation, the analytical method and the quantitative determination method in this measurement are mentioned below.

### (Analytical Instrumentation)

HSS: HP7694 (manufactured by Agilent Technologies)

GC: 6890 (manufactured by Agilent Technologies)

### (Analytical Method)

HSS:
oven temperature: 150° C.
heating time: 30 min
pressure time: 0.12 min
loop charge time: 0.12 min
loop equilibration time: 0.05 min
injection time: 0.50 min
sample loop temperature: 160° C.
transfer line temperature: 200° C.

GC:
column: DB-FFAP (0.530 mmφ×30 m, df=1.0 μM)
column temperature: 40° C. (5 min)→<+10° C./min>→90° C. (0 min)→<+20° C./min>→250° C. (2 min)
[This means that the column is kept at 40° C. for 5 minutes, then heated up to 90° C. at a heating speed of 10° C./min, and then further heated at a heating speed of 20° C./min up to 250° C., and thereafter kept at 250° C. for 2 minutes.]
column pressure: 24.6 kPa
column flow rate: 5.0 mL/min
carrier gas: He
injection port temperature: 250° C.
injection system: split (split ratio, 12:1)
detector: FID
detector temperature: 250° C.
injected amount: 1.0 mL

### (Quantitative Determination Method)

Toluene (commercially-available special grade chemical) is diluted with acetone and analyzed through GC; and from the concentration of the authentic preparation and the peak area, a calibration curve is drawn. Next, the sample is analyzed through GC; and from the toluene peak area, the toluene emission amount (μg/g) per gram of the pressure-sensitive adhesive tape in the sample (in the case of a double-sided adhesive tape, this is per gram of the weight of the adhesive tape as obtained by subtracting the weight of the aluminium foil from the weight of the sample) is computed. The repetition of measurement (test number, n) is, for example, preferably 3 times.

In the case of a double-sided pressure-sensitive adhesive tape, both pressure-sensitive adhesive sides of the tape are analyzed, and preferably, the emission amount of toluene from both the two sides satisfies the above range.

The formaldehyde emission amount from the pressure-sensitive adhesive tape of the invention is at most 3 μg/g, preferably at most 2 μg/g, more preferably at most 1 μg/g. When the formaldehyde emission amount is more than 3 μg/g, then it is unfavorable since the odor and VOC to be released from the pressure-sensitive adhesive tape may increase. The formaldehyde emission amount can be measured, for example, according to “Method for Measuring Formaldehyde Emission Amount” described below.

### [Method for Measuring Formaldehyde Emission Amount]

In case where the pressure-sensitive adhesive tape for optical member is a double-sided pressure-sensitive adhesive tape, the pressure-sensitive adhesive tape is cut into pieces each having a predetermined size (8 cm length×5 cm width×two pieces, test area 80 cm²); and when the tape has a separator, the separator is removed. One side (pressure-sensitive adhesive face) is stuck to an aluminium foil, and the other side is left open; and in this manner, test samples are prepared. On the other hand, in case where the pressure-sensitive adhesive tape for optical member is a single-sided pressure-sensitive adhesive tape, this is cut into two piece each having a predetermined size (8 cm length×5 cm width×two pieces, test area 80 cm²); and when the tape has a separator, the separator is removed, and test samples are thus prepared. The sample is weighed, then put into a U-shaped tube for sampling. Subsequently, the U-shaped tube with the sample therein is heated at 80° C. for 30 minutes in an oil bath, and the volatile component from the sample is trapped with a DNPH (dinitrophenylhydrazine) cartridge. After 30 minutes, the U-shaped tube is pulled up from the oil bath, and purged with nitrogen while the gas from the container is sucked with a pump. Next, the DNPH cartridge is removed, and aldehydes and ketones are converted into derivatives and are desorbed with 5 mL, of acetonitrile. The solution is analyzed through high-performance liquid chromatography (HPLC). The analytical instrumentation, the analytical method and the quantitative determination method in this measurement are mentioned below.

### (Analytical Instrumentation)

HPLC: Agilent 1100 (manufactured by Agilent Technologies)

### (Analytical Method)

HPLC:
column: L-Column 2ODS (4.6 mmφ×150 mm, 5 μm)
eluent: distilled water/acetonitrile=55/45 (v/v)
flow rate: 1.0 mL/min
detector: PDA (210 nm to 500 nm), 360 nm extraction
column temperature: 40° C.
injected amount: 10 μL

### (Quantitative Determination Method)

A formaldehyde-dinitrophenylhydrazine derivative (HCHO-DNPH) standard solution (containing formaldehyde in an amount of 500 μg/mL) is diluted with acetonitrile and analyzed through HPLC; and from the concentration of the authentic preparation and the peak area, a calibration curve is drawn. Next, the sample is analyzed through HPLC; and from the peak area of HCHO-DNPH, the formaldehyde emission amount (μg/g) per gram of the pressure-sensitive adhesive tape in the sample (in the case of a double-sided pressure-sensitive adhesive tape, this is per gram of the weight of the pressure-sensitive adhesive tape as obtained by subtracting the weight of the aluminium foil from the weight of the sample) is computed. The repetition of measurement (test number, n) is, for example, preferably 3 times. In addition, the U-shaped tube with aluminium foil therein is analyzed in the same manner as a blank. The repetition of the blank measurement (test number, n) is, for example, preferably two times.

In the case of a double-sided pressure-sensitive adhesive tape, both pressure-sensitive adhesive sides of the tape are analyzed, and preferably, the emission amount of formaldehyde from both the two sides satisfies the above range.

According to the pressure-sensitive adhesive tape of the invention, the toluene emission amount and the formaldehyde emission amount from it each fall within the above-mentioned specific range, so that the release of odor and VOC from the tape is reduced. Accordingly, the pressure-sensitive adhesive tape for optical member of the invention is favorable for use for in-vehicle installation, and for use for members near to users such as lenses, panels, etc. The emission amount of toluene and the emission amount of formaldehyde from the pressure-sensitive adhesive tape of the invention can be controlled by the polymerization method, the production method for the pressure-sensitive adhesive tape, the adhesive composition, etc.

The pressure-sensitive adhesive tape of the invention has at least one pressure-sensitive adhesive layer. If desired, this may have a separator (release liner) on the surface of the pressure-sensitive adhesive layer.

The pressure-sensitive adhesive tape of the invention may be a so-called “substrate-less type” pressure-sensitive adhesive tape having no substrate (substrate layer) (hereinafter this may be referred to as “substrate-less pressure-sensitive adhesive tape”), or a substrate-having pressure-sensitive adhesive tape. The substrate-less pressure-sensitive adhesive tape includes, for example, a double-sided pressure-sensitive adhesive tape that includes a pressure-sensitive adhesive layer alone. The substrate-having pressure-sensitive adhesive tape may have a pressure-sensitive adhesive layer on at least one side of the substrate; and for example, this includes a single-sided pressure-sensitive adhesive tape having a pressure-sensitive adhesive layer on only one side of the substrate, and a double-sided pressure-sensitive adhesive tape having a pressure-sensitive adhesive layer on both sides of the substrate. Above all, from the viewpoint of enhancing the optical properties such as the transparency thereof, preferred is the substrate-less pressure-sensitive adhesive tape. Herein, the above-mentioned “substrate (substrate layer)” does not include a separator to be released before use of the pressure-sensitive adhesive tape (for bonding).

The pressure-sensitive adhesive tape of the invention is not specifically defined so long as the toluene emission amount and the formaldehyde emission amount therefrom each satisfy the above-mentioned range.

The type of the pressure-sensitive adhesive (adhesive) to form the pressure-sensitive adhesive layer of the pressure-sensitive adhesive tape of the invention is not specifically defined. For example, there may be mentioned known pressure-sensitive adhesives such as acrylic pressure-sensitive adhesives, rubber pressure-sensitive adhesives, vinyl alkyl ether pressure-sensitive adhesives, silicone pressure-sensitive adhesives, polyester pressure-sensitive adhesives, polyamide pressure-sensitive adhesives, urethane pressure-sensitive adhesives, fluorine-containing pressure-sensitive adhesives, epoxy pressure-sensitive adhesives, etc. One or more of these pressure-sensitive adhesives may be used here either singly or as combined. The pressure-sensitive adhesive may have any form, and for example, herein usable are active energy ray-curable pressure-sensitive adhesives, solvent-based (solution-type) pressure-sensitive adhesives, emulsion pressure-sensitive adhesives, hot-melt pressure-sensitive adhesives, etc.

As the pressure-sensitive adhesive to form the above-mentioned pressure-sensitive adhesive layer, preferred is an acrylic pressure-sensitive adhesive from the viewpoint of enhancing the optical properties such as the transparency of the pressure-sensitive adhesive tape. Specifically, the pressure-sensitive adhesive layer of the pressure-sensitive adhesive tape of the invention is preferably an acrylic pressure-sensitive adhesive layer. The acrylic adhesive layer is a pressure-sensitive adhesive layer that contains, as the base polymer therein, an acrylic polymer formed of an acrylic monomer as an indispensable monomer ingredient. Not specifically defined, the content of the acrylic polymer (or acrylic polymer component) in the acrylic pressure-sensitive adhesive layer is preferably at least 60% by weight (for example, from 60 to 100% by weight), more preferably from 80 to 100% by weight.

Not specifically defined, as varying depending on the method for forming the pressure-sensitive adhesive layer, the acrylic pressure-sensitive adhesive may be formed of an acrylic pressure-sensitive adhesive composition comprising an acrylic polymer as the indispensable ingredient, or an acrylic pressure-sensitive adhesive composition comprising a monomer mixture for forming an acrylic polymer (this may be referred to as “monomer mixture”) or its prepolymer, as the indispensable ingredient. Not specifically defined, the former includes, for example, a so-called solvent-based pressure-sensitive adhesive composition, etc.; and the latter includes, for example, a so-called active energy ray-curable pressure-sensitive adhesive composition, etc. The pressure-sensitive adhesive composition may contain, if desired, a crosslinking agent and other various additives.

The “pressure-sensitive adhesive composition” implies a sense of “composition for forming pressure-sensitive adhesive layer”. The “monomer mixture” means a mixture containing exclusively monomer ingredients for forming an acrylic polymer. The “prepolymer” means a composition in which one or more of the constitutive ingredients of the monomer mixture are partly polymerized.

The acrylic polymer is preferably an acrylic polymer formed of an alkyl (meth)acrylate having a linear or branched alkyl group, and/or an alkoxyalkyl (meth)acrylate, as the essential monomer ingredient (more preferably as the main monomer ingredient). The above-mentioned “(meth)acryl” means “acryl” and/or “methacryl”, and the same shall apply to the others.

The monomer mixture for forming the acrylic polymer may further contain a polar group-containing monomer, a polyfunctional monomer and any other copolymerizable monomer as comonomer ingredient. The comonomer ingredient, if any, in the monomer mixture may improve the adhesiveness of the polymer to adherend and may enhance the cohesive power of the pressure-sensitive adhesive layer. One or more such comonomers may be used here either singly or as combined.

The above-mentioned alkyl (meth)acrylates having a linear or branched alkyl group (hereinafter this may be simply referred to as “alkyl (meth)acrylates”) are preferred for use herein. Examples of the alkyl (meth)acrylate include alkyl (meth)acrylates in which the alkyl group has from 1 to 20 carbon atoms, such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. One or more such alkyl (meth)acrylates may be used here either singly or as combined. Above all, preferred are alkyl (meth)acrylates in winch the alkyl group has from 1 to 14 carbon atoms; and more preferred are alkyl (meth)acrylates in which the alkyl group has from 1 to 10 carbon atoms. Even more preferred are 2-ethylhexyl acrylate and n-butyl acrylate.

Also preferred for use herein are the above-mentioned alkoxyalkyl (meth)acrylates. Especially preferred are alkoxyalkyl acrylates. Not specifically defined, examples of the alkoxyalkyl (meth)acrylate include 2-methoxyethyl (meth)acrylate, 2-ethoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate and 4-ethoxybutyl (meth)acrylate. One or more of such alkoxyalkyl (meth)acrylates may be used here either singly or as combined. Above all, preferred is 2-methoxyethyl acrylate.

The content of the indispensable monomer ingredient (alkyl (meth)acrylate and/or alkoxyalkyl (meth)acrylate) for forming the acrylic polymer is, from the viewpoint of the adhesiveness of the pressure-sensitive adhesive layer, preferably at least 5% by weight (for example, from 5 to 100% by weight), more preferably from 7 to 95% by weight, relative to the total monomer ingredients (100% by weight) for forming the acrylic polymer. In case where both alkyl (meth)acrylate and alkoxyalkyl (meth)acrylate are used as the monomer ingredients, it is sufficient that the total (total content) of the content of the alkyl (meth)acrylate and the content of the alkoxyalkyl (meth)acrylate satisfies the above range.

Examples of the above-mentioned polar group-containing monomer include carboxyl group-containing monomers such as (meth)acrylic acid, itaconic acid, maleic acid, fumaric acid, crotonic acid, isocrotonic acid, etc., and their anhydrides (maleic anhydride, etc.); hydroxyl group-containing monomers such as hydroxyalkyl (meth)acrylates, e.g., 2-hydroxyethyl (meth)acrylate, 3-hydroxypropyl (meth)acrylate, 4-hydroxybutyl (meth)acrylate, 6-hydroxyhexyl (meth)acrylate, etc., vinyl alcohol, allyl alcohol, etc.; amide group-containing monomers such as (meth)acrylamide, N,N-dimethyl (meth)acrylamide, N-methylol(meth)acrylamide, N-methoxymethyl(meth)acrylamide, N-butoxymethyl(meth)acrylamide, N-hydroxyethylacrylamide, etc.; amino group-containing monomers such as aminoethyl (meth)acrylate, dimethylaminoethyl (meth)acrylate, t-butylaminoethyl (meth)acrylate, etc.; glycidyl group-containing monomers such as glycidyl (meth)acrylate, methylglycidyl (meth)acrylate, etc.; cyano group-containing monomers such as acrylonitrile, methacrylonitrile, etc.; hetero ring-containing vinyl monomers such as N-vinyl-2-pyrrolidone, (meth)acryloylmorpholine, N-vinylpyridine, N-vinylpiperidone, N-vinylpyrimidine, N-vinylpiperazine, N-vinylpyrrole, N-vinylimidazole, N-vinyloxazole, etc.; sulfonic acid group-containing monomers such as sodium vinylsulfonate, etc.; phosphoric acid group-containing monomers such as 2-hydroxyethyl acryloylphosphate, etc.; imide group-containing monomers such as cyclohexylmaleimide, isopropylmaleimide, etc.; isocyanate group-containing monomers such as 2-methacryloyloxyethyl isocyanate, etc. One or more such polar group-containing monomers may be used here either singly or as combined. Of the above-mentioned polar group-containing monomers, preferred are amide group-containing monomers, hetero ring-containing vinyl monomers and hydroxyl group-containing monomers; and more preferred are hydroxyethylacrylamide, N-vinyl-2-pyrrolidone, 4-hydroxybutyl acrylate.

The content of the polar group-containing monomer is preferably from 1 to 30% by weight, more preferably from 3 to 20% by weight, relative to the total amount (100% by weight) of all the monomer ingredients for forming the acrylic polymer. When the content of the polar group-containing monomer is more than 30% by weight, the cohesive force of the pressure-sensitive adhesive layer may be too high and the adhesiveness of the pressure-sensitive adhesive layer may lower. When the content of the polar group-containing monomer is less than 1% by weight, the cohesive force of the pressure-sensitive adhesive layer may lower and the pressure-sensitive adhesive layer could not have a high shear adhesion strength, and the adhesiveness of the pressure-sensitive adhesive layer may therefore lower. Of the above, the content of the carboxyl group-containing monomer or its anhydride (especially acrylic acid) is preferably from 1 to 20% by weight, more preferably from 3 to 10% by weight, relative to the total (100% by weight) of all the monomer ingredients for forming the acrylic polymer, from the viewpoint of the adhesiveness of the pressure-sensitive adhesive layer. The content of the hydroxyl group-containing monomer (especially 4-hydroxybutyl acrylate) is preferably from 0.01 to 10% by weight, more preferably from 0.05 to 5% by weight, relative to the total (100% by weight) of all the monomer ingredients for forming the acrylic polymer, from the viewpoint of the crosslinkability.

Examples of the polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, and urethane acrylate.

The content of the polyfunctional monomer is at most 0.5% by weight (for example, from 0 to 0.5% by weight), preferably from 0 to 0.1% by weight, relative to the total (100% by weight) of all the monomer ingredients for forming the acrylic polymer. When the content thereof is more than 0.5% by weight, the cohesive force of the pressure-sensitive adhesive layer may become too high and the adhesiveness of the pressure-sensitive adhesive layer may lower. In case where a crosslinking agent is used, the polyfunctional monomer may not be used; but when a crosslinking agent is not used the content of the polyfunctional monomer is preferably from 0.001 to 0.5% by weight, more preferably from 0.002 to 0.1% by weight.

Examples of the comonomer other than the polar group-containing monomer and the polyfunctional monomer includes alicyclic hydrocarbon group-containing (meth)acrylates such as cyclopentyl (meth)acrylate, cyclohexyl (meth)acrylate, and isobornyl (meth)acrylate; aryl (meth)acrylates such as phenyl (meth)acrylate; vinyl esters such as vinyl acetate, and vinyl propionate; aromatic vinyl compounds such as styrene, and vinyltoluene; olefins or dienes such as ethylene, butadiene, isoprene, and isobutylene; vinyl ethers such as vinyl alkyl ether; and vinyl chloride.

The acrylic polymer may be produced by polymerizing the monomer ingredients according to a known or conventional polymerization method. The polymerization method for the acrylic polymer includes, for example, a solution polymerization method, an emulsion polymerization method, a bulk polymerization method, an active energy ray-irradiation polymerization method (active energy ray polymerization method), etc. Of those, preferred are a solution polymerization method and an active energy ray polymerization method from the viewpoint of transparency, the waterproofness and the cost of the polymer. From the viewpoint of reducing the toluene and formaldehyde emission amounts and the odor, more preferred is an active energy ray polymerization method (this may be referred to as a photopolymerization method); and even more preferred is a UV polymerization method with irradiation with UV rays.

Examples of the active energy rays to be radiated in the above active energy ray polymerization (photopolymerization) include ionizing radiations such as α rays, β rays, γ rays, neutron rays, and electron beams; and UV rays. Especially preferred are UV rays. The radiation energy, the radiation time and the radiation method for active energy rays are not specifically defined so long as the radiated rays could activate the photopolymerization initiator used to thereby initiate the reaction of the monomer ingredients.

In the solution polymerization, various ordinary solvents may be used. Examples of the solvent include organic solvents, for example, esters such as ethyl acetate, and n-butyl acetate; aromatic hydrocarbons such as toluene, and benzene; aliphatic hydrocarbons such as n-hexane, and n-heptane; alicyclic hydrocarbons such as cyclohexane, and methylcyclohexane; and ketones such as methyl ethyl ketone, and methyl isobutyl ketone. One or more such solvents may be used here either singly or as combined.

In producing the acrylic polymer, a polymerization initiator such as a photopolymerization initiator (optical initiator) or a thermal polymerization initiator may be used. One or more such polymerization initiators may be used here either singly or as combined.

Not specifically defined, examples of the photopolymerization initiator includes benzoin ether photopolymerization, initiators, acetophenone photopolymerization initiators, α-ketol photopolymerization initiators, aromatic sulfonyl chloride photopolymerization initiators, optical-active oxime photopolymerization initiators, benzoin photopolymerization initiators, benzyl photopolymerization initiators, benzophenone photopolymerization initiators, ketal photopolymerization initiators, and thioxanthone photopolymerization initiators. Not specifically defined, the amount of the photopolymerization, initiator to be used is preferably from 0.01 to 0.2 parts by weight, more preferably from 0.05 to 0.15 parts by weight, relative to 100 parts by weight of the total of all the monomer ingredients for forming the acrylic polymer.

Examples of the benzoin ether photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Examples of the acetophenone photopolymerization initiator include 2,2-diethoxyacetophenone, 2,2-dimethoxy-2-phenylacetophenone, 1-hydroxycyclohexylphenylacetophenone, 4-phenoxydichloroacetophenone, and 4-(t-butyl)dichloroacetophenone. Examples of the α-ketol photopolymerization initiator include 2-methyl-2-hydroxypropiophenone, and 1-[4-(2-hydroxyethyl)phenyl]-2-methylpropan-1-one. Examples of the aromatic sulfonyl chloride photopolymerization initiator include 2-naphthalenesulfonyl chloride. Examples of the optical-active oxime photopolymerization initiator include 1-phenyl-1,1-propanedione-2-(o-ethoxycarbonyl)-oxime. Examples of the benzoin photopolymerization initiator include benzoin. Examples of the benzyl photopolymerization initiator include benzyl. Examples of the benzophenone photopolymerization initiator include benzophenone, benzoylbenzoic acid, 3,3′-dimethyl-4-methoxybenzophenone, polyvinylbenzophenone, and α-hydroxycyclohexyl phenyl ketone. Examples of the ketal photopolymerization initiator include benzyl dimethyl ketal. Examples of the thioxanthone photopolymerization initiator include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

Examples of the polymerization initiator to be used in producing the acrylic polymer through solution polymerization include azo initiators, peroxide polymerization initiators (e.g., dibenzoyl peroxide, tert-butyl permaleate, etc.), and redox polymerization initiators. Above all, preferred are the azo initiators described in JP-A 2002-69411, herein incorporated by reference. The azo initiators are preferred since the decomposate of the initiator hardly remains in the acrylic polymer as a part to cause outgassing under heat. Examples of the azo initiator include 2,2′-azobisisobutyronitrile (hereinafter this may be abbreviated as AIBN), 2,2′-azobis-2-methylbutyronitrile (hereinafter this may be abbreviated as AMBN), dimethyl 2,2′-azobis(2-methylpropionate) and 4,4′-azobis-4-cyanovalerianic acid. The amount of the azo initiator to be used is preferably from 0.05 to 0.5 parts by weight, more preferably from 0.1 to 0.3 parts by weight, relative to 100 parts by weight of the total of all the monomer ingredients for forming the acrylic polymer.

Preferably, the weight-average molecular weight of the acrylic polymer is from 300,000 to 2,000,000, more preferably from 600,000 to 1,500,000, even more preferably from 700,000 to 1,500,000. When the weight-average molecular weight of the acrylic polymer is less than 300,000, then the polymer could not exhibit good adhesive properties; but on the other hand, when it is more than 2,000,000, then there may occur a problem in the coatability with the pressure-sensitive adhesive; and therefore either of the cases is unfavorable. The weight-average molecular weight can be controlled by the type and the amount of the polymerization initiator to be used, the temperature and the time in polymerization, the monomer concentration, the monomer dropping rate, etc.

The pressure-sensitive adhesive layer of the pressure-sensitive adhesive tape of the invention may contain, if desired, known additives such as a crosslinking agent, a crosslinking promoter, an antiaging agent, a filler, a colorant (pigment, dye, etc.), a UV absorbent, an antioxidant, a chain transfer agent, a plasticizer, a softener, a surfactant, an antistatic agent, etc., within a range not detracting from the characteristics of the invention. When the pressure-sensitive adhesive layer is formed, various ordinary solvents may be used. The type of the solvent is not specifically defined, and those exemplified hereinabove as the solvent for solution polymerization may be used.

The crosslinking agent acts to crosslink the base polymer (e.g., the above-mentioned acrylic polymer, etc.) in the pressure-sensitive adhesive layer to thereby control the gel fraction in the pressure-sensitive adhesive layer. Examples of the crosslinking agent include an isocyanate crosslinking agent, an epoxy crosslinking agent, a melamine crosslinking agent, a peroxide crosslinking agent, an urea crosslinking agent, a metal alkoxide crosslinking agent, a metal chelate crosslinking agent, a metal salt crosslinking agent, a carbodiimide crosslinking agent, an oxazoline crosslinking agent, an aziridine crosslinking agent, and an amine crosslinking agent. Preferred are an isocyanate crosslinking agent and an epoxy crosslinking agent. One or more such crosslinking agents may be used here either singly or as combined.

Examples of the isocyanate crosslinking agent include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylylene diisocyanate; aromatic polyisocyanates such as 2,4-tolylene diisocyanate, 2,6-tolylene diisocyanate, 4,4′-diphenylmethane diisocyanate, and xylylene diisocyanate. In addition, also usable are trimethylolpropane/tolylene diisocyanate adduct [Nippon Polyurethane Industry's trade name, “Coronate L”], trimethylolpropane/hexamethylene diisocyanate adduct [Nippon Polyurethane Industry's trade name, “Coronate HL”], etc.

Examples of the epoxy crosslinking agent include N,N,N′,N′-tetraglycidyl-m-xylylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol, polyglycidyl ether, pentaerythritol polyglycidyl ether, polyglycerol polyglycidyl ether, sorbitan polyglycidyl ether, trimethylolpropane polyglycidyl ether, diglycidyl adipate, diglycidyl o-phthalate, triglycidyl tris(2-hydroxyethyl)isocyanurate, resorcin diglycidyl ether, bisphenol S diglycidyl ether, as well as epoxy resins having at least two epoxy groups in the molecule, etc. As a commercial product, for example, herein usable is Mitsubishi Gas Chemical's trade name, “Tetrad C”.

Not specifically defined, the amount of the crosslinking agent to be used is, for example, in an acrylic pressure-sensitive adhesive layer, preferably from 0 to 1 part by weight, more preferably from 0 to 0.8 parts by weight, relative to 100 parts by weight of the total of all the monomer ingredients for forming the acrylic polymer.

Preferably, the pressure-sensitive adhesive layer of the pressure-sensitive adhesive tape of the invention does not substantially contain a tackifying resin from the viewpoint of reducing the toluene and formaldehyde emission amounts and the odor from the layer. “Not substantially contain” herein means that the layer does not actively contain the ingredient excepting a case where the ingredient is inevitably contained in the layer. Concretely, the content of the tackifying resin in the pressure-sensitive adhesive layer is preferably less than 1% by weight, more preferably less than 0.1% by weight, relative to the total weight of the pressure-sensitive adhesive layer. In case where the pressure-sensitive adhesive composition and the pressure-sensitive adhesive layer contain a tackifying resin, toluene, formaldehyde and odor may be much released from the pressure-sensitive adhesive tape when the pressure-sensitive adhesive layer is heated. Concrete examples of the tackifying resin include rosin derivatives, polyterpene resins, petroleum resins and oil-soluble phenols.

For forming the pressure-sensitive adhesive layer of the pressure-sensitive adhesive tape of the invention, any known or conventional, pressure-sensitive adhesive layer formation methods may be employed. Depending on the polymerization method for the base polymer, the pressure-sensitive adhesive layer formation method varies, and is therefore not specifically defined. For example, the following methods (1) to (3) are mentioned.

(1) A composition containing a mixture of monomer ingredients (monomer mixture) to form a base polymer (for example, an acrylic polymer, etc.) or its prepolymer, and optionally additives such as a photopolymerization initiator, a crosslinking agent or the like is applied onto a substrate or separator by coating, and irradiated with active energy rays (especially preferably UV rays) to form a pressure-sensitive adhesive layer thereon.

(2) A composition (solution) containing a base polymer, a solvent, and optionally additives such as a crosslinking agent or the like is applied onto a substrate or separator by coating, and dried and/or cured to form a pressure-sensitive adhesive layer thereon.

(3) The pressure-sensitive adhesive layer formed according to (1) is further dried.

Of the above, preferred is the pressure-sensitive adhesive layer formation method (1) or (3) from the viewpoint of reducing the toluene and formaldehyde emission amounts and the odor emission amount; and more preferred is the pressure-sensitive adhesive layer formation method (3). Specifically, the pressure-sensitive adhesive layer of the pressure-sensitive adhesive tape of the invention is preferably formed by irradiating a pressure-sensitive adhesive composition containing a monomer mixture or its prepolymer and optionally additives such as a photopolymerization initiator, a crosslinking agent or the like, with active energy rays (especially UV rays).

The method of forming the pressure-sensitive adhesive layer of the pressure-sensitive adhesive tape of the invention preferably includes a drying step after the formation of the pressure-sensitive adhesive layer, from the viewpoint of reducing the toluene and formaldehyde emission amounts and the odor emission amount.

In case where the pressure-sensitive adhesive layer is formed of a pressure-sensitive adhesive composition (solution) containing a base polymer (for example, an acrylic polymer, etc.), a solvent, and optionally additives such as a crosslinking agent or the like, preferably, the composition (solution) is applied onto a substrate or a separator by coating, then dried and/or cured thereon, and is further processed in a subsequent drying step. The drying condition in the subsequent drying step (for additional drying after previous drying and/or curing) is not specifically defined; but from the viewpoint of reducing the toluene and formaldehyde emission amounts and the odor emission amount, it is desirable that the additional drying is conducted generally at 100 to 150° C. for 1 to 3 minutes.

In case where the pressure-sensitive adhesive layer is formed of a pressure-sensitive adhesive composition containing a mixture of monomer ingredients to form a base polymer (for example, an acrylic polymer, etc.) or its prepolymer, and optionally additives such as a photopolymerization initiator, a crosslinking agent or the like, it is preferable that the composition is applied onto a substrate or a separator by coating, and then irradiated with active energy rays (preferably UV rays) for active energy ray polymerization to form a pressure-sensitive adhesive layer, and is further processed in a drying step. The drying condition in the drying step is not specifically defined; but from the viewpoint of reducing the toluene and formaldehyde emission amounts and the odor emission amount, it is desirable that the drying is conducted generally at 100 to 150° C. for 1 to 3 minutes.

For the coating with the composition for forming the pressure-sensitive adhesive layer, employable is any known coating method with an ordinary coater, for example, a gravure coater, a reverse coater, a kiss roll coater, a dip roll coater, a bar coater, a knife coater, a spray coater, a comma coater, a direct coater, etc.

One example of a preferred concrete constitution of the pressure-sensitive adhesive layer of the pressure-sensitive adhesive tape of the invention is a pressure-sensitive adhesive layer (acrylic pressure-sensitive adhesive layer) formed through active energy ray polymerization of a composition that contains a mixture of monomer ingredients of, as indispensable ingredients, an alkyl (meth)acrylate and/or an alkoxyalkyl (meth)acrylate (monomer mixture), or its prepolymer, by irradiation with active energy rays. Especially preferred is a pressure-sensitive adhesive layer (acrylic pressure-sensitive adhesive layer) formed by further drying the pressure-sensitive adhesive layer formed through the active energy ray polymerization, at 100 to 150° C. for 1 to 3 minutes. Preferably, the composition for forming the pressure-sensitive adhesive layer contains a photopolymerization initiator. If desired, the composition may contain a crosslinking agent and other additives.

In case where the pressure-sensitive adhesive tape of the invention is a substrate-having pressure-sensitive adhesive tape, examples of the substrate include, but not specifically defined thereto, various types of optical films such as plastic films, antireflection (AR) films, polarizers, retarders, etc. The material of the plastic films include plastic materials, for example, polyester resins such as polyethylene terephthalate (PET), acrylic resins such as polymethyl methacrylate (PMMA), polycarbonates, triacetyl cellulose, polysulfones, polyarylates, cyclic olefin polymers such as Arton (cyclic olefin polymer, JSR's trade name), and Zeonoa (cyclic olefin polymer, Nippon Zeon's trade name). One or more such plastic materials may be used here either singly or as combined. The “substrate” is a part of the pressure-sensitive adhesive tape that is, when the tape is applied (stuck) to an adherend (optical member, etc.), stuck to the adherend along with the pressure-sensitive adhesive layer of the tape. A separator (release liner) to be removed in use (application) of the pressure-sensitive adhesive tape is not within the category of the “substrate”.

Of the above, preferred is a transparent substrate. The “transparent substrate” is, for example, preferably one having a whole light transmittance (according to JIS K 7361) in a visible light wavelength region of at least 85%, more preferably at least 90%. Examples of the transparent substrate include PET films, and nonorientation films such as Arton (trade name) and Zeonoa (trade name).

Not specifically defined, the thickness of the substrate is, for example, preferably from 12 to 50 μm. The substrate may have a single-layer or multi-layer structure. The surface of the substrate may be suitably processed for known or conventional surface treatment of physical treatment such as corona discharge treatment, plasma treatment or the like, or chemical treatment such as undercoating treatment, etc.

The surface (pressure-sensitive adhesive face) of the pressure-sensitive adhesive layer of the pressure-sensitive adhesive tape of the invention may be protected with a separator (release liner) before use. In case where the pressure-sensitive adhesive tape of the invention is a double-sided pressure-sensitive adhesive tape, the two pressure-sensitive adhesive faces may be protected individually with different separators, or may be protected with one separator of which the two faces are both release faces, in the form of a wound roll of the tape. The separator serves as a protective material for the pressure-sensitive adhesive layer, and is removed when the tape is stuck to an object. In case where the pressure-sensitive adhesive tape of the invention is a substrate-less pressure-sensitive adhesive tape, the separator plays an additional role as the support for the pressure-sensitive adhesive layer. The separator is not always needed. As the separator, usable is any ordinary release paper or the like. Not specifically defined, also usable are substrates having a release treatment layer, a poorly-adhesive substrate composed of a fluorine-containing polymer, a poorly-adhesive substrate composed of a non-polar polymer, etc. Examples of the substrate having a release treatment layer include plastic films and paper surface-treated with a release treatment agent such as silicone compounds, long-chain alkyl compounds, fluorine compounds and molybdenum sulfide. Examples of the fluorine-containing polymer for the poorly-adhesive substrate composed of a fluorine-containing polymer include polytetrafluoroethylene, polychlorotrifluoroethylene, polyvinyl fluoride, polyvinylidene fluoride, tetrafluoroethylene/hexafluoroethylene copolymer and chlorofluoroethylene/vinylidene fluoride copolymer. Examples of the non-polar polymer includes olefin resins (e.g., polyethylene, polypropylene). The separator may be formed in any known or conventional method. The thickness of the separator is not specifically defined.

Not specifically defined, the thickness of the pressure-sensitive adhesive layer in the pressure-sensitive adhesive tape of the invention is preferably from 10 to 300 μm, more preferably from 20 to 200 μm, even more preferably from 50 to 200 μm. When the thickness of the pressure-sensitive adhesive layer is less than 10 μm, then the pressure-sensitive adhesive tape could hardly have good adhesiveness; but when it is more than 200 μm, the pressure-sensitive adhesive tape may release a lot of VOC and odor. The pressure-sensitive adhesive layer of the pressure-sensitive adhesive tape of the invention may have a single-layer or multi-layer structure.

Preferably, the pressure-sensitive adhesive tape of the invention has high transparency; and for example, the whole light transmittance in a visible light region (according to JIS K 7361) of the tape is preferably at least 90%, more preferably at least 91%. The haze value of the pressure-sensitive adhesive tape of the invention (according to JIS K 7361) is, for example, preferably less than 1.0%, more preferably less than 0.8%. The whole light transmittance and the haze value may be measured, for example, by sticking the pressure-sensitive adhesive tape of the invention to a slide glass (for example, having a whole light transmittance of 91% and a haze value of 0.4%) and analyzing it with a haze meter (Murakami Color Search Laboratory's trade name “HM-150”).

The 180-degree peel adhesion force with respect to an acrylic plate of the pressure-sensitive adhesive tape of the invention (this is referred to as “peel adhesion force (with respect to acrylic plate, 180° peeling)”) is at least 10 N/25 mm (for example, from 10 to 30 N/25 mm), preferably at least 12 N/25 mm. When the peel adhesion force (with respect to acrylic plate, 180° peeling) is less than 10 N/25 mm, the adhesion reliability of the tape may be poor. The peel adhesion force (with respect to acrylic plate, 180° peeling) may be determined in a 180° peeling test where the adherend is an acrylic plate. Concretely, for example, according to JIS Z0237, an acrylic plate (Mitsubishi Rayon's “Acrylite” having a thickness of 2 mm) is used as an adherend (test plate), the surface of the pressure-sensitive adhesive layer of the pressure-sensitive adhesive tape of the invention is stuck to the adherend, and then peeled at 180° under the condition of a peeling speed of 300 mm/min, and the intended peel adhesion force of the tape is thereby measured. In case where the pressure-sensitive adhesive tape is a double-sided pressure-sensitive adhesive tape, a liner (PET film, Toray's “Lumirror S-10” having a thickness of 25 μm) is stuck to the surface of the pressure-sensitive adhesive layer (pressure-sensitive adhesive face) on the side opposite to the side to be analyzed. In the case of the double-sided pressure-sensitive adhesive tape, preferably, the two pressure-sensitive adhesive faces thereof both satisfy the above range in point of the peel adhesion force (with respect to acrylic plate, 180° peeling) thereof.

The pressure sensitive adhesive tape for optical member of the invention is used for optical members. Not specifically defined, for example, the tape is favorably used in sticking optical members (for use for sticking optical members), or in producing a pressure-sensitive adhesive-type optical member by sticking the pressure-sensitive adhesive tape of the invention to the surface of an optical member. The optical member is meant to indicate a member having optical properties (for example, polarization, light refractivity, light scatterability, light reflectivity, light transmission, light absorption, light diffraction, optical rotation, or visibility). Not specifically defined, the optical member may be any member having optical properties, and includes, for example, members constituting instruments such as display devices (image display devices), input devices, etc., and members for use for those instruments. For example, they include polarizer, wave plate, retarder, optical compensatory film, brightness increasing film, light guide plate, reflection film, antireflection film, transparent conductive film (ITO film, etc.), design film, decoration film, surface protective film, prism, color filter, hard coat film, transparent substrate, and members laminated with these. “Plate” and “film” as referred to herein shall include plate-like, film-like and sheet-like forms; and for example, “polarization plate” shall include “polarization film” and “polarization sheet”.

Examples of the display device include liquid-crystal display devices, organic EL (electroluminescent) display devices, PDP (plasma display panels), and electronic papers. Examples of the input device include touch panels.

Not specifically defined, examples of the optical member include members (e.g., sheet-like, film-like or plate-like members) made of acrylic resin, polycarbonate, polyethylene terephthalate, glass, metal thin film, etc. The “optical member” in the invention may include members that play a role of decoration or protection (design film, decoration film, surface protective film, etc.) while securing the visibility of the adherend such as display device and input device, as described in the above.

In case where the pressure-sensitive adhesive tape of the invention is used for sticking optical members, the sticking mode is not specifically defined. For example, (1) an optical member may be stuck to another optical member via the pressure-sensitive adhesive tape of the invention; (2) an optical member may be stuck to a member different from an optical member via the pressure-sensitive adhesive tape of the invention; or (2) the pressure-sensitive adhesive tape of the invention that includes an optical member is stuck to an optical member or a member different from an optical member. In the embodiment (1) or (2), the pressure-sensitive adhesive tape of the invention is preferably a double-sided pressure-sensitive adhesive tape; and in the embodiment (3), the pressure-sensitive adhesive tape of the invention may be any of a single-sided pressure-sensitive adhesive tape or a double-sided pressure-sensitive adhesive tape. In the embodiment (3), the substrate of the pressure-sensitive adhesive tape of the invention is preferably an optical member (e.g., optical film such as typically a polarization film).

### EXAMPLES

The invention is described in more detail with reference to the following Examples, to which, however, the invention should not be limited.

### Example 1

0.05 parts by weight of “Irgacure 184” (trade name by Ciba Specialty Chemicals and 0.05 parts by weight of “Irgacure 651” (trade name by Ciba Specialty Chemicals), both serving as a photopolymerization initiator, were added to a mixture of 68 parts by weight of 2-ethylhexyl acrylate (2EHA), 24 parts by weight of 2-methoxyethyl acrylate (2MEA), 6 parts by weight of N-vinyl-2-pyrrolidone (NVP) and 2 parts by weight of N-hydroxyethylacrylamide (HEAA), and then irradiated with UV rays until its viscosity (as measured with a BM viscometer No. 5 rotor, 10 rpm, temperature 30° C.) could reach about 20 Pa·s thereby preparing a prepolymer composition where a part of the monomer ingredients were polymerized.

0.30 parts by weight of an isocyanate crosslinking agent (Nippon Polyurethane Industry's “Coronate HL”) was added to the prepolymer composition prepared in the above to give a pressure-sensitive adhesive composition.

The pressure-sensitive adhesive composition was applied onto a polyethylene terephthalate (PET) separator (Mitsubishi Resin's “MRF75”) so that the final thickness (pressure-sensitive adhesive layer thickness) could be 175 μm, thereby forming a coating layer. Next, another PET separator (Mitsubishi Resin's “MRF38”) was provided on the coating layer, with which the coating layer was coated so as to be blocked from oxygen. Subsequently, the laminate of MRF75/coating layer/MRF38 was irradiated with UV rays at an illumination intensity of 5 mW/cm² from a black light (by Toshiba), on the top (on the side of MRF38) thereof for 300 seconds. Further, this was dried in a drier at 130° C. for 2 minutes to remove the remaining monomers through evaporation, thereby forming a pressure-sensitive adhesive layer; and further this was aged under heat at 50° C. for 1 week, thereby producing a pressure-sensitive adhesive tape (substrate-less pressure-sensitive adhesive tape) having a thickness of 175 μm. In Table 1, the added amount (blended amount) of the isocyanate crosslinking agent (Coronate L, Coronate HL) is expressed in terms of the solid-equivalent added amount thereof (part by weight).

### Example 2

A pressure-sensitive adhesive tape (substrate-less pressure-sensitive adhesive tape) having a thickness of 175 μm was produced in the same manner as in Example 1, for which, however, the drying treatment at 130° C. for 2 minutes was omitted as in Table 1.

### Example 3

95 parts by weight of n-butyl acrylate, 5 parts by weight of acrylic acid, 0.2 parts by weight of 2,2′-azobisisobutyronitrile serving as a polymerization initiator, and 186 parts by weight of ethyl acetate as a polymerization solvent (solvent medium) were put into a separable flask, and stirred for 1 hour with introducing nitrogen gas thereinto. After oxygen was removed from the polymerization system in that manner, this was heated up to 63° C. and reacted for 10 hours, and then toluene was added thereto to give an acrylic polymer solution having a solid concentration of 30% by weight.

To the acrylic polymer solution, added was an epoxy crosslinking agent (Mitsubishi Gas Chemical's trade name, “Tetrad C”) in an amount of 0.075 parts by weight relative to 100 parts by weight of the acrylic polymer, thereby giving a pressure-sensitive adhesive composition (solution).

The pressure-sensitive adhesive composition (solution) was cast onto a PET separator (Mitsubishi Resin's “MRF75”), dried under normal pressure at 60° C. for 1 minutes and at 155° C. for 2 minutes to form a pressure-sensitive adhesive layer, and then this was further dried at 130° C. for 2 minutes to reduce the emission amounts of toluene and formaldehyde and the emission of odor from it. Next, another PET separator (Mitsubishi Resin's “MRF38”) was provided on the pressure-sensitive adhesive layer, and further aged at 50° C. for 72 hours to produce a pressure-sensitive adhesive tape (substrate-less adhesive tape) having a thickness of 50 μm.

### Example 4

A prepolymer composition was prepared in the same manner as in Example 1, for which, however, a mixture of 90 parts by weight of isononyl acrylate and 10 parts by weight of acrylic acid was used as in Table 1.

0.2 parts by weight of trimethylolpropane triacrylate was added to the thus-prepared prepolymer composition as in Table 1, to give a pressure-sensitive adhesive composition.

Using the pressure-sensitive adhesive composition and in the same manner as in Example 1, a pressure-sensitive adhesive tape (substrate-less pressure-sensitive adhesive tape) having a thickness of 150 μm was produced.

### Comparative Example 1

95 parts by weight of n-butyl acrylate and 5 parts by weight of acrylic acid were processed in 230 parts by weight of toluene for solution polymerization in the presence of 0.2 parts by weight of benzoyl peroxide (BPO) and with stirring under purging with nitrogen at 60 to 80° C., thereby preparing an acrylic polymer solution having a viscosity of about 120 poises, a conversion ratio for polymerization of 99% and a solid concentration of 30.0% by weight. To the solution, added were 30 parts by weight, relative to 100 parts by weight of the solid content of the solution, of a polymer rosin ester resin (Arakawa Chemical Industry's “Pensel D-125”) having a softening point of 125° C. and 4 parts by weight of an isocyanate crosslinking agent (Nippon Polyurethane Industry's “Coronate L”), and mixed to prepare a pressure-sensitive adhesive composition (solution).

On the other hand, an addition-polymerization dimethylsiloxane polymer layer was provided on the surface of a glassine paper to prepare a release liner. The above-mentioned pressure-sensitive adhesive composition (solution) was applied onto the surface of the release liner, and dried at 130° C. for 5 minutes to form a pressure-sensitive adhesive layer (adhesive layer) having a thickness of 70 μm thereon. Next, a hemp/rayon nonwoven fabric (thickness, about 50 μm) was laminated on the pressure-sensitive adhesive layer, and the above-mentioned pressure-sensitive adhesive composition (solution) was further applied onto the other surface of the nonwoven fabric, and dried at 130° C. for 5 minutes, thereby producing a pressure-sensitive adhesive tape having a total thickness of 160 μm.

### (Evaluation)

The pressure-sensitive adhesive tapes produced in Examples and Comparative Example were analyzed or evaluated according to the measurement methods and the evaluation method mentioned below. The whole light transmittance, the peel adhesion force (with respect to acrylic plate, 180° peeling) and the odor level were evaluated as mentioned below. The toluene emission amount and the formaldehyde emission amount were determined in the manner mentioned above. The test evaluation results are shown in Table 1.

### (1) Whole Light Transmittance:

The separator was peeled from each pressure-sensitive adhesive tape produced in Examples and Comparative Example, and the tape was stuck to a slide glass (Matsunami Glass's trade name “S-1111” having a haze value of 0.4%) to prepare a test piece having a layer constitution of pressure-sensitive adhesive layer/slide glass (however, the test piece of the pressure-sensitive adhesive tape of Comparative Example had a layer constitution of pressure-sensitive adhesive layer/nonwoven fabric/pressure-sensitive adhesive layer/slide glass). Using a haze meter (Murakami Color Research Laboratory's trade name “HM-150”), the while light transmittance (%) of the test piece was measured.

(2) Peel Adhesion Force (with Respect to Acrylic Plate, 180° Peeling):

A test piece having a width of 25 mm and a length of 150 mm was cut out of each pressure-sensitive adhesive tape produced in Examples, the separator (MRF38) was peeled, and a PET film (Toray's “Lumirror S-10”) having a thickness of 25 μm was stuck (for lining) to the thus-exposed pressure-sensitive adhesive face (opposite to the pressure-sensitive adhesive face for measurement) of the test piece thereby preparing a strip-like tape piece.

Next, the separator (MRF75) was peeled from the strip-like tape piece, and the thus-exposed pressure-sensitive adhesive face (for measurement) of the tape piece was stuck to an acrylic plate (Mitsubishi Rayon's “Acrylite” having a thickness of 2 mm) by applying a 2-kg rubber roller (width: about 50 mm) thereonto for one back-and-forth movement, thereby preparing a test sample.

The test sample was put in an atmosphere at 23° C. and 50% RH for 0.5 hours, and then, using a tensile tester according to JIS Z 0237, this was tested for the peel adhesion force (with respect to acrylic plate, 180° peeling) (N/25 mm). Concretely, the test sample was tested in an atmosphere at 23° C. and 50% RH, at a peeling angle of 180° and at a pulling speed of 300 mm/min. The repetition of measurement (test number, n) was 3 times (n=3).

The pressure-sensitive adhesive tape produced in Comparative Example was tested as follows: Of the pressure-sensitive adhesive layers, one formed by direct application to the substrate (nonwoven fabric) (directly-applied pressure-sensitive adhesive layer) was lined with a PET film, and the pressure-sensitive adhesive layer formed by transfer to the substrate (transferred pressure-sensitive adhesive layer) was stuck to the acrylic plate. Thus prepared, the test sample was tested in the same manner as above for the peel adhesion force (with respect to acrylic plate, 180° peeling).

### (3) Odor:

A tape piece having a width of 100 mm and a length of 100 mm was cut out of each pressure-sensitive adhesive tape produced in Examples and Comparative Example. From the test piece of each double-sided pressure-sensitive adhesive tape of Examples, the separator (MRF38) was peeled away. Thus prepared, the test pieces were checked for the odor through organoleptic evaluation. The samples releasing little solvent odor are evaluated as pressure-sensitive adhesive tapes with excellent low-VOC-property (A); and those releasing a lot of solvent odor are evaluated as pressure-sensitive adhesive tapes with poor low-VOC-property (B). The results are shown in Table 1. The repetition of measurement of the individual adhesive tapes (test number, n) was 3 times (n=3).

TABLE 1

| | Monomer | | | | | | | | | |
|---|---|---|---|---|---|---|---|---|---|---|
| | Formulation | Formulation of Adhesive Composition | | | | | | | | |
| | Composition | prepolymer | | | | | | | Constitution of | |
| | type of monomer | composition, | | | | | | | Adhesive Tape | |
| | monomer | acrylic | | Coronate | | | Process | | thickness | |
| | blend ratio | polymer⁽*¹⁾ | Coronate L | HL | Tetrad C | TMPTA | polymerization | drying | of tape | |
| | (by weight) | (wt. pt.) | (wt. pt.) | (wt. pt.) | (wt. pt.) | (wt. pt.) | method | treatment | (μm) | substrate |
| Example 1 | 2EHA/2MEA/ | 100 | | 0.30 | | | UV | yes | 175 | no |
| | NVP/HEAA | | | | | | | | | |
| | 68/24/6/2 | | | | | | | | | |
| Example 2 | 2EHA/2MEA/ | 100 | | 0.30 | | | UV | no | 175 | no |
| | NVP/HEAA | | | | | | | | | |
| | 68/24/6/2 | | | | | | | | | |
| Example 3 | BA/AA | 100 | | | 0.075 | | solution | yes | 50 | no |
| | 95/5 | | | | | | | | | |
| Example 4 | iNA/AA | 100 | | | | 0.2 | UV | yes | 150 | no |
| | 90/10 | | | | | | | | | |
| Comparative | BA/AA | 100 | 4.00 | | | | solution | yes | 160 | yes |
| Example 1 | 95/5 | | | | | | | | | (nonwoven |
| | | | | | | | | | | fabric) |

| | Evaluation | | | | |
|---|---|---|---|---|---|
| | toluene emission | formaldehyde | whole light transmittance | peel adhesion force (to acrylic | |
| | amount | emission amount | (inclusive of slide glass) | plate, 180° peeling) | |
| | (μg/g) | (μg/g) | (%) | (N/25 mm) | odor |
| Example 1 | 0.4 | 0.8 | 92 | 20 | A |
| Example 2 | 2.8 | 0.8 | 92 | 20 | A |
| Example 3 | 1.9 | 0.5 | 92 | 20 | A |
| Example 4 | 0.5 | lower than | 92 | 25 | A |
| | | predetermined | | | |
| | | detection limit | | | |
| | | <0.04 | | | |
| Comparative | 800.0 | 0.5 | 5 | 15 | B |
| Example I | | | | | |

⁽*¹⁾A prepolymer composition was used in Examples 1, 2 and 4; and an acrylic polymer was used in Example 3 and Comparative Example 1.

The abbreviations in the Table are as follows:

2EHA: 2-ethylhexyl acrylate
2MEA: 2-methoxyethyl acrylate
NVP: N-vinyl-2-pyrrolidone
HEAA: hydroxyethylacrylamide
BA: n-butyl acrylate
AA: acrylic acid
iNA: isononyl acrylate
Coronate L: Nippon Polyurethane Industry's trade name “Coronate L” (isocyanate crosslinking agent)
Coronate HL: Nippon Polyurethane Industry's trade name “Coronate HL” (isocyanate crosslinking agent)
Tetrad C: Mitsubishi Gas Chemical's trade name “Tetrad C” (epoxy crosslinking agent)
TMPTA: trimethylolpropane triacrylate

While the present invention has been described in detail and with reference to specific embodiments thereof, it will be apparent to one skilled in the art that various changes and modifications can be made therein without departing from the scope thereof.

This application is based on Japanese patent application No. 2009-140500 filed Jun. 11, 2009, the entire contents thereof being hereby incorporated by reference.

What is claimed is:

1. A pressure-sensitive adhesive tape for optical member, which has a toluene emission amount of at most 10 μg/g and a formaldehyde emission amount of at most 3 μg/g.

2. The pressure-sensitive adhesive tape for optical member according to claim 1, which comprises an acrylic pressure-sensitive adhesive layer.

3. The pressure-sensitive adhesive tape for optical member according to claim 1, which has a whole light transmittance of at least 90%.

4. The pressure-sensitive adhesive tape for optical member according to claim 1, which has a peel adhesion force (with respect to acrylic plate, 180° peeling) of at least 10 N/25 mm.

5. The pressure-sensitive adhesive tape for optical member according to claim 1, which is a substrate-less pressure-sensitive adhesive tape having no substrate.

6. The pressure-sensitive adhesive tape for optical member according to claim 2, wherein the acrylic pressure-sensitive adhesive layer contains an acrylic polymer formed of as an indispensable monomer ingredient, an alkyl (meth)acrylate having a linear or branched alkyl group having from 1 to 14 carbon atoms, and/or an alkoxyalkyl (meth)acrylate.

7. The pressure-sensitive adhesive tape for optical member according to claim 2, wherein the acrylic pressure-sensitive adhesive layer is formed of a pressure-sensitive adhesive composition prepared in accordance with a UV polymerization method through irradiation with UV rays.
